(19) United States
(12) Patent Application Publication
(10) Pub. No.: US 2024/0159611 A1
(43) Pub. Date: May 16, 2024

(54) PRESSURE TRANSDUCERS HAVING IMPROVED RESISTANCE TO TEMPERATURE ERROR

(71) Applicant: Illinois Tool Works Inc., Glenview, IL (US)

(72) Inventors: Hai Mei, Pelham, NH (US); Ethan Earnest, JENKINTOWN, PA (US)

(21) Appl. No.: 18/506,683

(22) Filed: Nov. 10, 2023

Related U.S. Application Data
(60) Provisional application No. 63/424,712, filed on Nov. 11, 2022.

(51) Int. Cl. G01L 19/04; G01L 9/00

(52) U.S. Cl. CPC G01L 19/04; G01L 9/0042

(57) ABSTRACT

Disclosed example pressure sensors include: a first body defining a reference pressure cavity; a second body defining a measured pressure cavity and having an inlet configured to receive a fluid; a diaphragm between the reference pressure cavity and the measured pressure cavity; a single electrode comprising a plate portion having a first face facing the diaphragm and separated from the diaphragm by a gap to form a capacitance between the electrode and the diaphragm; an electrode extension fixed to the electrode and extending through an aperture in the first body; an electrically insulative joint disposed between the electrode extension and the first body at least partially within the aperture; and wherein the first body, the electrode, and the electrode extension have respective geometries and coefficients of thermal expansion selected such that, in response to changes in temperature, combined expansion of the electrode and the electrode extension offsets changes in the gap resulting from expansion of the first body.

### RELATED APPLICATIONS

The present application claims the benefit of U.S. Provisional Patent Application Ser. No. 63/424,712, filed Nov. 11, 2022, entitled “PRESSURE TRANSDUCERS HAVING IMPROVED RESISTANCE TO TEMPERATURE ERROR.” The entirety of U.S. Provisional Patent Application Ser. No. 63/424,712 is expressly incorporated herein by reference.

### FIELD OF THE DISCLOSURE

This disclosure is directed generally to pressure transducers and, more particularly, to pressure transducers having improved resistance to temperature error.

### BACKGROUND

Pressure sensors, or pressure transducers, measure the pressure of a fluid input to the sensor compared to a reference pressure. Pressure sensors may be constructed to compare the input pressure to a fixed reference pressure or to a variable reference pressure.

### SUMMARY

Pressure transducers having improved resistance to temperature error are disclosed, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1A is a block diagram of an example process control system including a pressure transducer having a fixed reference pressure, in accordance with aspects of this disclosure.

FIG. 1B is a block diagram of an example process control system including a pressure transducer coupled to a variable source of reference pressure, in accordance with aspects of this disclosure.

FIG. 2 is a schematic diagram of an example pressure sensor which may be used to implement the pressure sensors of FIGS. 1A and/or 1B, in accordance with aspects of this disclosure.

FIG. 3 is an exploded perspective view of the example pressure measurement assembly of FIG. 2.

FIG. 4 is another exploded perspective view of the example pressure measurement assembly of FIG. 2.

FIG. 5 is a flowchart representative of an example method which may be performed to assemble the example pressure sensor of FIG. 2.

The figures are not necessarily to scale. Wherever appropriate, similar or identical reference numerals are used to refer to similar or identical components.

### DETAILED DESCRIPTION

For the purpose of promoting an understanding of the principles of the claimed technology and presenting its currently understood, best mode of operation, reference will be now made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

Conventional pressure sensors convert input pressures to pressure signals. Some conventional sensors detect pressure differences between an input pressure and a reference pressure based on a capacitance between a flexible diaphragm and a fixed electrode. However, conventional capacitive pressure sensors are sensitive to temperature differences, in that changes in temperature may cause friction between contacting components and/or changes in the capacitance present between the diaphragm and the electrode. For example, thermal expansion of the components in conventional pressure sensors may cause a change in the gap between the diaphragm and the electrode, resulting in error in the pressure measurements. To reduce thermally induced error, some conventional capacitive pressure sensors include multiple electrodes, including a reference electrode to compensate for changes in temperature.

Disclosed example pressure transducers provide improved pressure sensing by reducing sensitivity to changes in temperature while using a single electrode (e.g., omitting reference electrodes). In some examples, a pressure measurement assembly includes a first body that defines a reference pressure cavity in conjunction with the diaphragm, and in which the electrode is present. The geometries and/or the materials of the first body, the electrode, and/or an electrode extension are selected to offset thermal expansion to thereby reduce or eliminate thermally induced error.

Disclosed pressure transducers may be less expensive and/or less complex to construct, more reliable, and/or easier to service and/or maintain than conventional capacitive pressure sensors. In some examples, a getter that is typically used in vacuum pressure manometers may be eliminated by coating the reference pressure cavity with a non-outgassing coating, such as Parylene-C.

Disclosed example pressure transducers have improved performance compared to conventional capacitive pressure sensors due to improved thermal performance and/or improved signal strength relative to multiple-electrode pressure sensors due to the omission of the reference electrodes and associated subtraction of signals.

As used herein, the term “fluid” includes matter in both liquid and gaseous states.

Disclosed example pressure sensors include: a first body defining a reference pressure cavity; a second body defining a measured pressure cavity and having an inlet configured to receive a fluid; a diaphragm between the reference pressure cavity and the measured pressure cavity; a single electrode having a plate portion having a first face facing the diaphragm and separated from the diaphragm by a gap to form a capacitance between the electrode and the diaphragm; an electrode extension fixed to the electrode and extending through an aperture in the first body; an electrically insulative joint disposed between the electrode extension and the first body at least partially within the aperture, in which the first body, the electrode, and the electrode extension have respective geometries and coefficients of thermal expansion selected such that, in response to changes in temperature (e.g., rise in temperature), combined expansion of the electrode and the electrode extension offsets changes in the gap resulting from expansion of the first body.

In some example pressure sensors, the electrically insulative joint provides a hermetic seal between the electrode extension and the first body. In some examples, the seal includes glass. In some example pressure sensors, the first body has a higher coefficient of thermal expansion than both the seal and the electrode extension. In some example pressure sensors, the seal forms a compression seal between the first body and the electrode extension.

In some example pressure sensors, the first body includes an evacuation port. In some example pressure sensors, the evacuation port is capable of selective sealing to fix a pressure within the reference pressure cavity. Some example pressure sensors further include a getter within the reference pressure cavity, in which the fixed pressure is a vacuum pressure. In some example pressure sensors, an internal surface of the first body is coated to reduce outgassing.

In some example pressure sensors, the evacuation port is configured to be coupled to a source of reference pressure to configure the pressure sensor as a differential pressure sensor. In some example pressure sensors, the evacuation port is configured to be vented to an ambient pressure to configure the pressure sensor as a gauge pressure type. In some example pressure sensors, the first body includes a corrosion resistant alloy.

In some example pressure sensors, the electrode extension comprises a Kovar® alloy or alloy 52. In some example pressure sensors, the electrode includes metal such as stainless steel having a higher coefficient of thermal expansion than the first body material. Some example pressure sensors further include measurement circuitry coupled to the electrode extension and configured to convert the capacitance between the electrode and the diaphragm to a pressure value.

In some example pressure sensors, the diaphragm is secured between the first body and the second body around a circumference of the diaphragm. In some example pressure sensors, the first body and the second body are welded around a circumference of the first body and the second body, with the diaphragm secured between the first body and the second body.

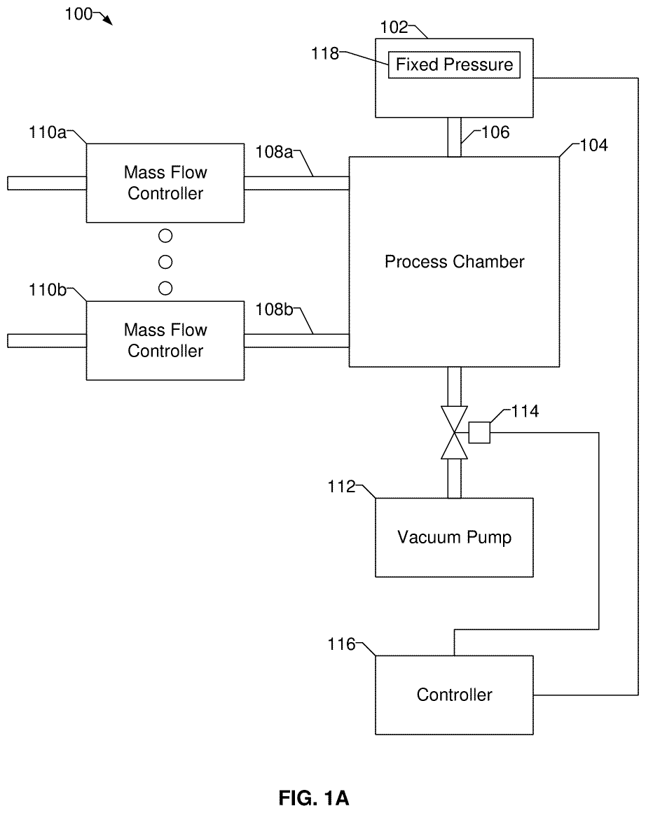

FIG. 1A is a block diagram of an example process control system 100 including a pressure transducer 102. The example process control system 100 of FIG. 1 includes a process chamber 104, to which the pressure transducer 102 is fluidly coupled via a fluid input line 106 to measure the pressure of the process chamber 104.

The example process chamber 104 may receive one or more inputs, such as process feed materials, via a corresponding number of feed lines 108a, 108b, which may be controlled via mass flow controllers 110a, 110b.

The example system 100 may include a vacuum pump 112, or other pressure control pump, and a valve 114 to control a flow rate between the vacuum pump 112 and the process chamber 104. The valve 114 may be controlled by a controller 116, computing device, and/or any other control technique, to maintain the pressure in the process chamber 104 within a desired range. The example pressure transducer 102 is communicatively coupled to the controller 116 to provide pressure feedback to the controller 116 (e.g., for use in a pressure control loop). For example, as the pressure in the process chamber 104 increases, the pressure transducer 102 measures the pressure and provides a signal representative of the pressure to the controller 116, which then controls the valve 114 to increase the flow rate from the process chamber 104 to the vacuum pump 112. The vacuum pump 112 may have an output to any appropriate location based on the nature of the process.

In the example of FIG. 1A, the pressure transducer 102 is configured with a fixed pressure 118, to which an input pressure of a fluid received via the fluid input line 106 is compared to output a pressure signal. For example, as discussed in more detail below, the pressure transducer 102 may be provided with a sealable evacuation port which may be sealed when the desired pressure is provided within the pressure transducer 102, and/or the pressure transducer 102 may be assembled and sealed within a volume having the desired reference pressure. The fixed pressure 118 may be a vacuum pressure or another predetermined fixed reference pressure which may be below, at, or above a nominal atmospheric pressure. In the configuration of FIG. 1A, the pressure transducer 102 may be used as an absolute pressure sensor.

FIG. 1B is a block diagram of another example process control system 150. The example process control system 150 includes the example pressure transducer 102, the process chamber 104, the fluid input line 106, the feed lines 108a, 108b, the mass flow controllers 110a, 110b, the vacuum pump 112, the valve 114, and the controller 116 of FIG. 1A. In the example of FIG. 1B, the pressure transducer 102 is coupled to a variable source 152 of reference pressure that is external to the pressure transducer 102. For example, the pressure transducer 102 may have a port (e.g., a selectively sealable evacuation port) that is connected to a source of reference pressure to operate as a pressure sensor with a variable reference, and/or which is vented to an ambient pressure to operate as a pressure gauge.

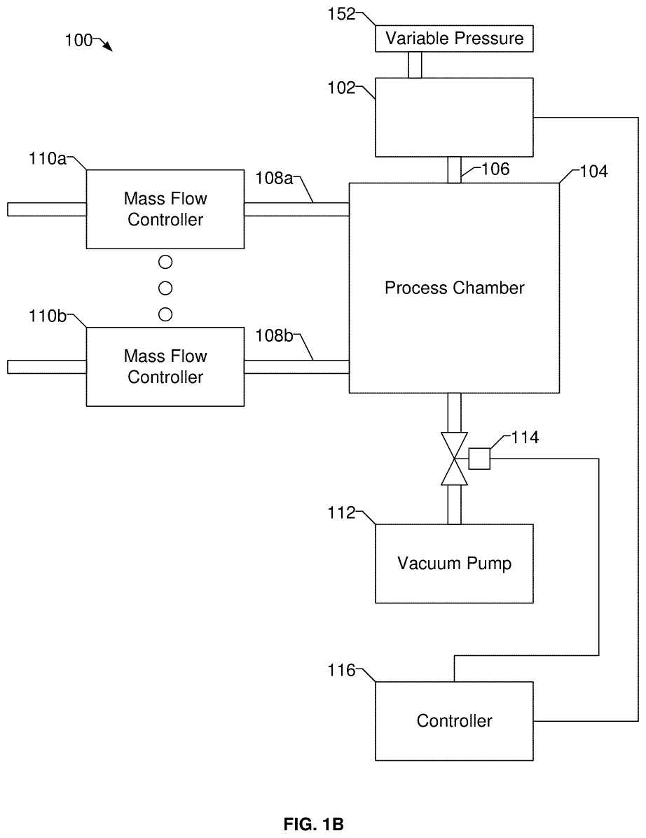

FIG. 2 is a schematic diagram of an example pressure transducer 200 which may be used to implement the pressure transducers 102, 150 of FIGS. 1A and/or 1B. The example pressure transducer 200 includes a pressure measurement assembly 202, an inner housing 204, and an outer housing 206. The pressure transducer 200 receives a fluid via a fluid input line 208 (e.g., the fluid input line 106 of FIG. 1), measures the absolute pressure of the received fluid, and outputs one or more signals representative of the measured pressure.

The pressure measurement assembly 202 is attached to the fluid input line 208. The pressure measurement assembly 202 may also be referred to as the “sensor core,” in that the pressure measurement assembly 202 performs the measurements which are converted to output signals. The pressure measurement assembly 202 is at least partially surrounded by the inner housing 204. The inner housing 204 may provide thermal insulation and/or physical protection to the pressure measurement assembly 202. Both the pressure measurement assembly 202 and the inner housing 204 are at least partially surrounded by the outer housing 206.

In the illustrated example, the pressure measurement assembly 202 is a capacitance pressure sensor, in which a flexible diaphragm 210 is separated from an electrode 212 by a gap 214. The pressure measurement assembly 202 includes a first body 216 that defines a reference pressure cavity 218, and a second body 220 that defines a measured pressure cavity 222. The second body 220 is coupled to the fluid input line 208, such that the measured pressure cavity 222 has the same pressure as the fluid in the fluid input line 208. For example, the second body 220 may be welded, brazed, or otherwise sealed against the fluid input line 208 to provide a hermetic seal.

The example electrode 212 has a face 224 that faces the diaphragm 210, and which is separated from the diaphragm by a substantially constant gap. The diaphragm 210 and the electrode 212 form a capacitance which changes as the distance between the diaphragm 210 and the electrode 212 changes, and which can be measured to determine the relative pressure between the reference pressure cavity 218 and the measured pressure cavity 222.

To measure the capacitance, the electrode 212 is coupled to an electrode extension 226, which extends from the electrode 212 through an aperture 228 in the first body 216 to an exterior of the first body 216. The electrode extension 226 may be integral or attached to the electrode 212. The electrode 212 and the electrode extension 226 may be collectively referred to herein as an electrode assembly.

The example pressure measurement assembly 202 further includes a joint 230 positioned between the electrode extension 226 and the first body 216, at least partially within the aperture 228. The joint 230 provides electrical insulation between the electrode extension 226 and the first body 216.

The diaphragm 210 is positioned between the first and second bodies 216, 220, which are welded or otherwise mechanically and hermetically attached together. The dimensions of the first body 216, the electrode 212, and the electrode extension 226 establishes the gap 214 between the electrode 212 and the diaphragm 210.

In some examples, the joint 230 further provides a hermetic seal. For example, the joint 230 may be implemented using a glass insert, such as S8061-type glass. To form the hermetic seal, the materials of the first body 216, the joint 230, and the electrode extension 226 may be selected such that the coefficient of thermal expansion of the first body 216 is larger than the coefficients of thermal expansion of both the joint 230 and the electrode extension 226. The seal provided by the joint 230 may be established by heating the first body 216, the joint 230, and the electrode extension 226, causing the joint 230 to melt. During subsequent cooling, the joint 230 solidifies while the first body 216 and the electrode extension 226 shrink. When the first body 216, the joint 230, and the electrode extension 226 are cooled, the larger coefficient of thermal expansion of the first body 216 causes the first body 216 to compress the joint 230 and the electrode extension 226.

The example first body 216, the electrode 212, and the electrode extension 226 also have configured geometries and materials such that combined expansion of the electrode 212 and the electrode extension 226 offsets changes in the gap 214 resulting from expansion of the first body 216. For example, as the temperature of the pressure measurement assembly 202 increases, the first body 216 expands such that the electrode extension 226 and the electrode 212 are pulled in a direction away from the diaphragm. On the other hand, the electrode 212 and the electrode extension 226 expand as the temperature increases to move the face 224 of the electrode 212 toward the diaphragm. The example first body 216, the electrode 212, and the electrode extension 226 of the example pressure measurement assembly 202 have geometries and materials (e.g., coefficients of thermal expansion) that offset the changes in the gap 214 that would occur due to the expansion of the first body 216 with offsetting expansion by of the electrode extension 226 and the electrode 212.

As an example, the first body 216 may be constructed to have a particular dimension 232 corresponding to the height of the reference pressure cavity 218. Additionally, the first body 216 is constructed of a material which has a first coefficient of linear thermal expansion (also referred to herein as coefficient of thermal expansion) CLTE_{body}. The electrode 212 is constructed to have a height dimension 234, and the electrode extension 226 has a partial height dimension 236 between the interface with the electrode 212 and the interior end of the aperture 228 (e.g., where the joint 230 constrains movement of the electrode extension 226). The electrode 212 is constructed with a material having a second coefficient of thermal expansion CLTE_{electrode}, and the electrode extension 226 is constructed with a material having a third coefficient of thermal expansion CLTEₑₓₜ. Equation 1 below shows the relationship between the dimensions 232-236 and the coefficients of thermal expansion:

body height 232*CLTE_{body}=(electrode height 234*CLTE_{electrode})+(partial extension height 236*CLTEₑₓₜ) (Equation 1)

Due to the body height dimension 232 being larger than the sum of the electrode height dimension 234 and the partial extension height dimension 236, at least one of the coefficients of thermal expansion CLTE_{electrode} and/or CLTEₑₓₜ is larger than the coefficient of thermal expansion of the first body 216.

Example materials that may be used to construct the first body 216 and/or the second body 220 include corrosion resistant alloys, such as nickel alloys (e.g., Inconel® alloy) and/or superalloys, cobalt superalloys, iron superalloys, aluminum, copper alloys, titanium, and/or stainless steel.

Example materials that may be used to construct the electrode extension 226 include low thermal expansion alloys such as a Kovar® alloy or alloy 52. As used herein, “low thermal expansion” refers to coefficients of thermal expansion up to 6×10⁻⁶/° F.

Example materials that may be used to construct the electrode 212 include stainless steels and/or other metals, which have higher coefficients of expansion than the material used to construct the first body 216.

As the pressure at the fluid input line 208 changes relative to the reference pressure in the reference pressure cavity 218, the diaphragm 210 deflects and changes the capacitance responding to the pressure at the fluid input line 208. The capacitance signal is output from the pressure measurement assembly 202 via the electrode extension 226, which is coupled to measurement circuitry 238 that converts the capacitance to a measurement signal and/or outputs the capacitance signal to an external signal conversion device. The measurement circuitry 238 may correct the measurement signal(s). The measurement signal(s), representative of the measured pressure in the pressure measurement assembly 202, may then be transmitted by the measurement circuitry 238 (e.g., to the controller 116 of FIG. 1A or 1B, to another control and/or data collection device, etc.) via a communications port 240 (e.g., a connector).

In the example of FIG. 2, the example measurement circuitry 238 and the communications port 240 are mounted within the pressure transducer 200 on one or more circuit boards 250. The example circuit boards 250 in FIG. 2 are positioned in a parallel orientation with reference to the diaphragm 210. In other examples, one or more of the circuit boards 250 are mounted in other orientations, such as perpendicularly to the diaphragm 210, to improve the packaging and/or resilience of the pressure measurement assembly 202.

To set a fixed reference pressure, the first body 216 may include an evacuation port 242 (e.g., a pinch tube or pinch-off tube). The evacuation port 242 is in fluid communication with the reference pressure cavity 218. During manufacturing and after sealing of the pressure measurement assembly 202, the pressure (e.g., vacuum or other set pressure) within the reference pressure cavity 218 is drawn via the evacuation port 242, which is pinched to seal the reference pressure cavity 218 when the desired pressure level is reached. In some other examples, the pressure measurement assembly 202 may be constructed and sealed in a volume in which the desired reference pressure is present, which fixes the desired reference pressure within the reference pressure cavity 218 when the evacuation port 242 is sealed via welding or pinch-off cold welding in a fixed pressure chamber.

In some examples in which a fixed reference pressure is set, a getter may be installed within the reference pressure cavity 218 and activated during manufacture, such as when the fixed reference pressure is established but before the reference pressure cavity 218 is sealed. Additionally or alternatively, the inner surfaces of the reference cavity 218 (e.g., the first body 216 adjacent the reference pressure cavity 218, the electrode 212, and/or the electrode extension 226) are coated with a substance that reduces or prevents outgassing. An example coating that may be used is Parylene-C.

In some other examples, the evacuation port 242 may be left open to ambient pressure and/or connected to a variable source of reference pressure.

The example pressure measurement assembly 202 further includes a plasma shield 244, which protects the diaphragm 210 from build-up of process byproducts and particulates from the fluid input line 208.

The inner housing 204 is attached to the second body 220 (e.g., using glue, welding, pressure fit, etc.). The outer housing 206 is secured to the measurement circuitry 238 and/or to the inner housing 204 (e.g., via fasteners, adhesive, welding, etc.).

In the example of FIG. 2, the second body 220 further includes a guard volume 246 which is recessed from the plasma shield 244 and from the diaphragm 210. The guard volume 246 accumulates depositions of particulates that may be introduced into the measured pressure cavity 222 via the fluid input line 208. By accumulating particulate in the guard volume 246, the deposition of particulate on the diaphragm is reduced and the lifespan of the diaphragm 210 is extended.

In some examples, the evacuation port 242 is sufficiently large as to facilitate the use of masking fixtures for applying the coating (e.g., Parylene-C) after attachment of the inner housing 204 to the second body 220. In such examples, the evacuation port 242 may be sealed using a plug 248. Following application of the coating, the plug 248 may be inserted into the evacuation port 242 during establishment of the reference pressure, and electron beam welded or otherwise fixed into the evacuation port 242 to seal the reference pressure within the reference pressure cavity 218.

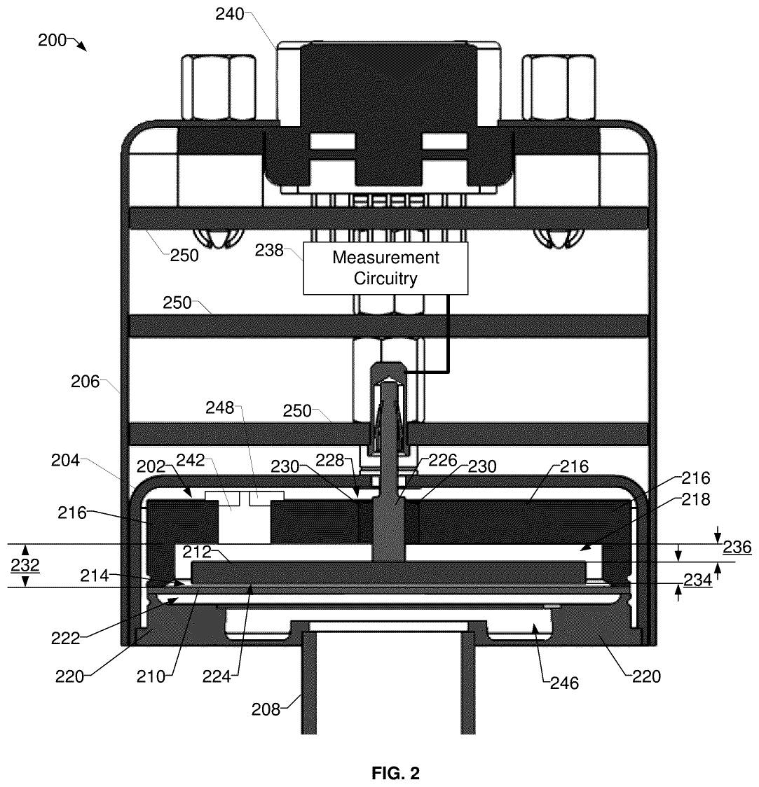

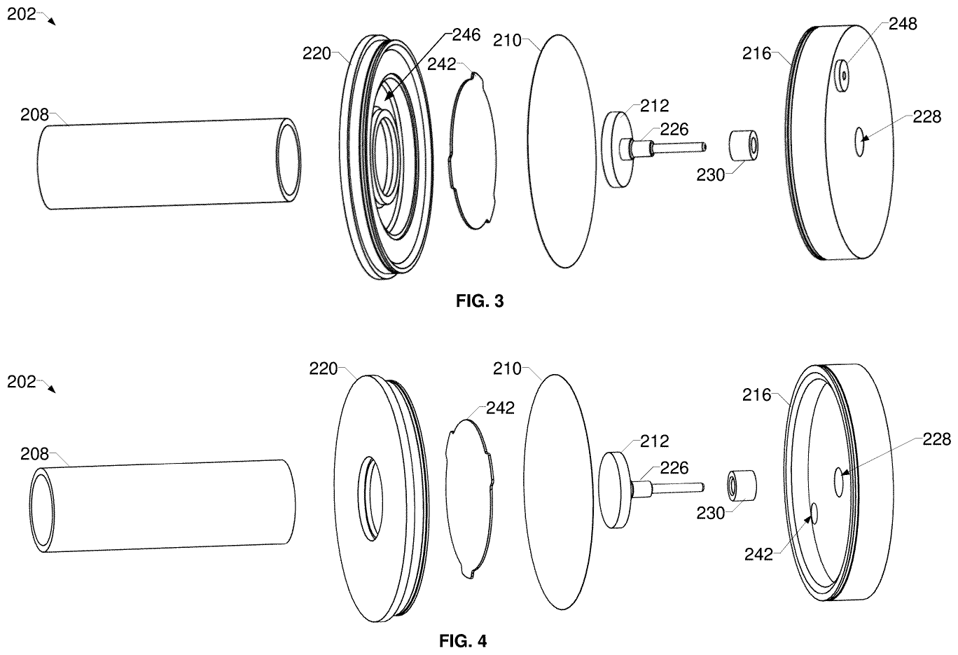

FIG. 3 is an exploded perspective view of the example pressure measurement assembly 202 of FIG. 2. FIG. 4 is another exploded perspective view of the example pressure measurement assembly 202 of FIG. 2.

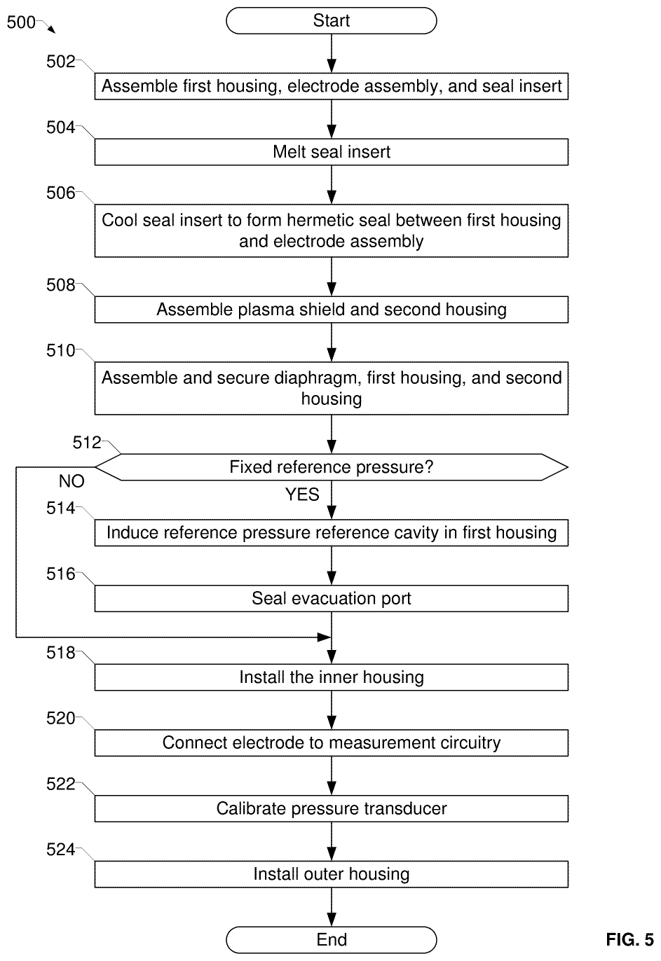

FIG. 5 is a flowchart representative of an example method 500 which may be performed to assemble the example pressure transducer 200 of FIG. 2. While an example manufacturing method is described with reference to FIG. 5, other methods may be used, such as methods involving additive manufacturing and/or other techniques that reduce the number of joining operations to be performed.

At block 502, the first body 216, the electrode assembly (e.g., the electrode 212 and electrode extension 226) and a seal preform (e.g., the joint 230) are assembled.

At block 504, the seal preform (e.g., the joint 230) is melted and at block 506 the seal preform is cooled to form a solid hermetic seal between the first body 216 and the electrode assembly. In some examples, block 504 and 506 may be omitted where a hermetic seal is not used.

At block 508, the plasma shield 244 and the second body 220 are assembled. At block 510, the diaphragm 210, the first body 216, and the second body 220 are assembled and secured (e.g., via welding).

If the reference pressure in the reference pressure cavity 218 is to be a fixed reference pressure (block 512), at block 514 the desired reference pressure is induced in the reference pressure cavity 218 in the first body 216. For example, the reference pressure may be drawn through the evacuation port 242. At block 516, the evacuation port 242 is sealed to fix the reference pressure.

After fixing the reference pressure (block 516), or if a fixed reference pressure is not to be used) at block 518, the inner housing 204 is installed. For example, the pressure measurement assembly 202 may be inserted into the inner housing 204 and the electrode extension 226 extends through the inner housing 204.

At block 520, the electrode assembly (e.g., via the electrode extension 226) is connected to the measurement circuitry 238.

At block 522, the pressure transducer 200 is calibrated for various pressures and/or temperatures.

At block 524, the outer housing 206 is installed. For example, the inner housing 204 and/or the outer housing 206 may be welded, glued, or otherwise attached to the pressure measurement assembly 202 and/or the fluid input line 208.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y,z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made, and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A pressure sensor, comprising:
a first body defining a reference pressure cavity;
a second body defining a measured pressure cavity and having an inlet configured to receive a fluid;
a diaphragm between the reference pressure cavity and the measured pressure cavity;
a single electrode comprising a plate portion having a first face facing the diaphragm and separated from the diaphragm by a gap to form a capacitance between the electrode and the diaphragm;
an electrode extension fixed to the electrode and extending through an aperture in the first body;
an electrically insulative joint disposed between the electrode extension and the first body at least partially within the aperture; and
wherein the first body, the electrode, and the electrode extension have respective geometries and coefficients of thermal expansion selected such that, in response to changes in temperature, combined expansion of the electrode and the electrode extension offsets changes in the gap resulting from expansion of the first body.

2. The pressure sensor as defined in claim 1, wherein the electrically insulative joint provides a hermetic seal between the electrode extension and the first body.

3. The pressure sensor as defined in claim 2, wherein the seal comprises glass.

4. The pressure sensor as defined in claim 2, wherein the first body has a higher coefficient of thermal expansion than both the seal and the electrode extension.

5. The pressure sensor as defined in claim 2, wherein the seal forms a compression seal between the first body and the electrode extension.

6. The pressure sensor as defined in claim 1, wherein the first body comprises an evacuation port.

7. The pressure sensor as defined in claim 6, wherein the evacuation port is capable of selective sealing to fix a pressure within the reference pressure cavity.

8. The pressure sensor as defined in claim 7, further comprising a getter within the reference pressure cavity, wherein the fixed pressure is a vacuum pressure.

9. The pressure sensor as defined in claim 7, wherein an internal surface of the first body is coated to reduce outgassing.

10. The pressure sensor as defined in claim 6, wherein the evacuation port is configured to be coupled to a source of reference pressure to configure the pressure sensor as a differential pressure sensor.

11. The pressure sensor as defined in claim 6, wherein the evacuation port is configured to be vented to an ambient pressure to configure the pressure sensor as a gauge type.

12. The pressure sensor as defined in claim 1, wherein the first body comprises a corrosion resistant alloy.

13. The pressure sensor as defined in claim 1, wherein the electrode extension comprises a Kovar® alloy or alloy 52.

14. The pressure sensor as defined in claim 1, wherein the electrode comprises stainless steel having a higher coefficient of thermal expansion than the first body material.

15. The pressure sensor as defined in claim 1, further comprising measurement circuitry coupled to the electrode extension and configured to convert the capacitance between the electrode and the diaphragm to a pressure value.

16. The pressure sensor as defined in claim 1, wherein the diaphragm is secured between the first body and the second body around a circumference of the diaphragm.

17. The pressure sensor as defined in claim 1, wherein the first body and the second body are welded around a circumference of the first body and the second body, with the diaphragm secured between the first body and the second body.
